(19) United States
(12) Patent Application Publication
(10) Pub. No.: US 2017/0374399 A1
(43) Pub. Date: Dec. 28, 2017

(54) COMPUTING INFRASTRUCTURE FOR MOVIE MAKING, PRODUCT PLACEMENTS AND DISTRIBUTION

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 15/195,065

(22) Filed: Jun. 28, 2016

Related U.S. Application Data
(63) Continuation of application No. 15/191,472, filed on Jun. 23, 2016.

(51) Int. Cl. H04N 21/234; H04N 21/81; H04N 21/472; H04N 21/2668; H04N 21/262; H04N 21/854; H04N 21/2547

(52) U.S. Cl. CPC H04N 21/23424; H04N 21/854; H04N 21/812; H04N 21/2547; H04N 21/2668; H04N 21/262; H04N 21/47202

(57) ABSTRACT

A computing infrastructure for movie making, product placements in the movie, etc. It provides movie creation and post-production services and supports clearance. Product placement services are provided for digital media of all kinds such as movies, video clips, audio clips, etc. The processing starts when a new digital media is created/uploaded by a user. Then detection of placeholder objects (one or more) is facilitated. The output is a catalog of placeholder objects. The user can review this output and modify it, and store it for subsequent processing. Then the user can replace placeholder objects with product placement material to create a modified digital media that is distributed.

### CROSS REFERENCES TO RELATED APPLICATIONS

This patent application makes reference to and claims priority from U.S. non-provisional application Ser. No. 15/191,472 filed on 23 Jun. 2016, titled “COMPUTING INFRASTRUCTURE FOR MOVIE MAKING AND PRODUCT PLACEMENTS”, which is hereby incorporated by reference in its entirety.

### BACKGROUND

### 1. Technical Field

The present invention relates generally to movie making and specifically to product placements in movies.

### 2. Related Art

Several types of movies are being made where manufacturers of products are accommodated, and products are strategically placed in the movies made. For example, products placed such as Apple computers are prominently placed in different scenes in a movie. Product placements typically take the form of a product manufacturer funding the movie makers at least partially to ensure that their products get prominence in the movie or as part of a story. This requires the movie makers to spend time and energy to recruit product manufacturers and spend significant time and energy in acquiring funds from them. Some product manufacturers are not satisfied in how their products are featured in the completed movie and complain about the wasted money and efforts.

One of the objects of the present invention is the making of product placements easy and efficient. Another of the objects of the present invention is the need to make product placements possible in video clips made by non-professionals and individuals. There is just no way non-professional movie makers or individuals making small video clips can effectively make product placements or even think about getting product manufacturers involved in their movie making.

To solve some of these problems and offload some of these responsibilities, product manufacturers have begun to make/produce movies themselves. For example, Lego corporation makes Lego based movies and distributes them. However such attempts are few and far between and product manufacturers really don't want to be movie makers, they would rather focus on getting out a better product.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1A is a perspective block diagram of a network comprising a computing infrastructure for processing digital media such as movies, comprising a product placement capture service (sometimes referred to as placeholder identification manager) that determines placeholder objects, and a automatic replacement manager that selectively replaces some of those placeholder objects identified, wherein the replacements made are driven by product placement needs of product manufacturers and product promoters;

FIG. 1B is a perspective diagram of an exemplary infrastructure for enhancing movies, the infrastructure comprising a digital media and a product placement placeholder determination service that provides a first interface data received via a promotion capture interface of a first promoter system, to a first product placement placeholder determination software application;

FIG. 2 is a perspective block diagram of a infrastructure for product placements in movies and other forms of digital media, wherein a digital media processing server receives and processes a digital media provided by a digital media production system and conducts post-production product placement activities as well as clearance management activities;

FIG. 3 is a perspective block diagram of a infrastructure for product placements in movies and other forms of digital media, wherein a server processes the digital media, facilitates product placements, and distributes a modified digital media with product placements included in them; and

FIG. 4 is a flowchart of an exemplary operation of the infrastructure of FIG. 1 as it facilitates automated product placements activities in digital media uploaded.

### DETAILED DESCRIPTION OF THE DRAWINGS

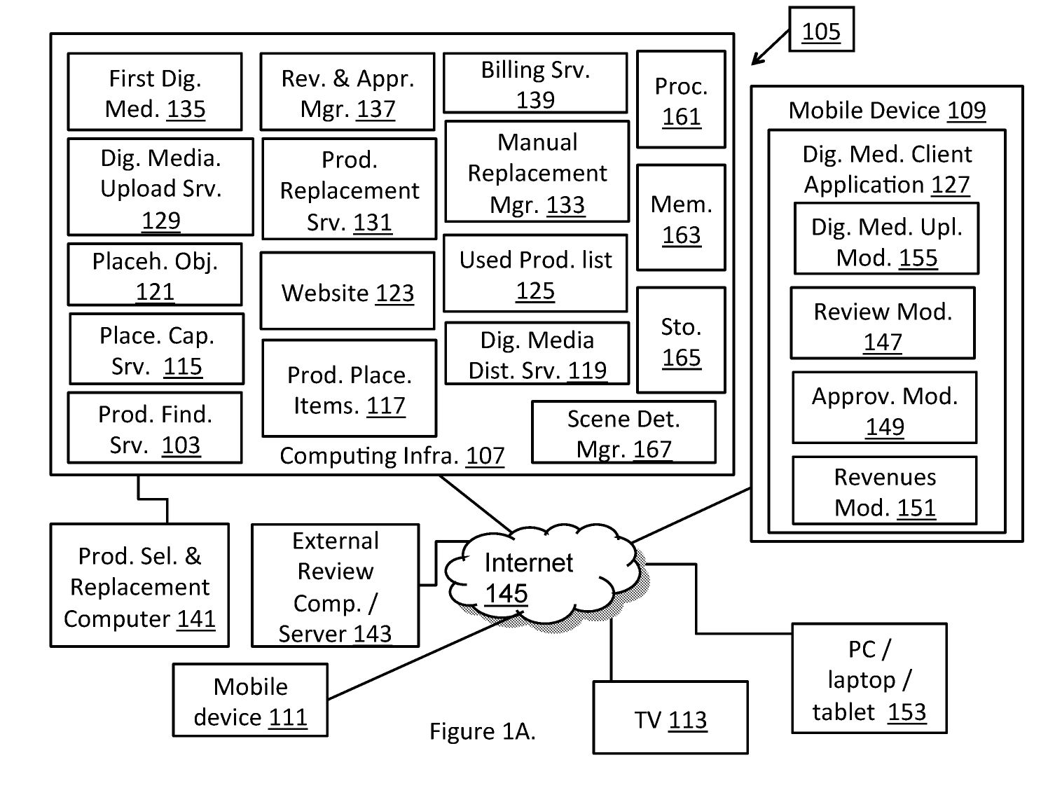

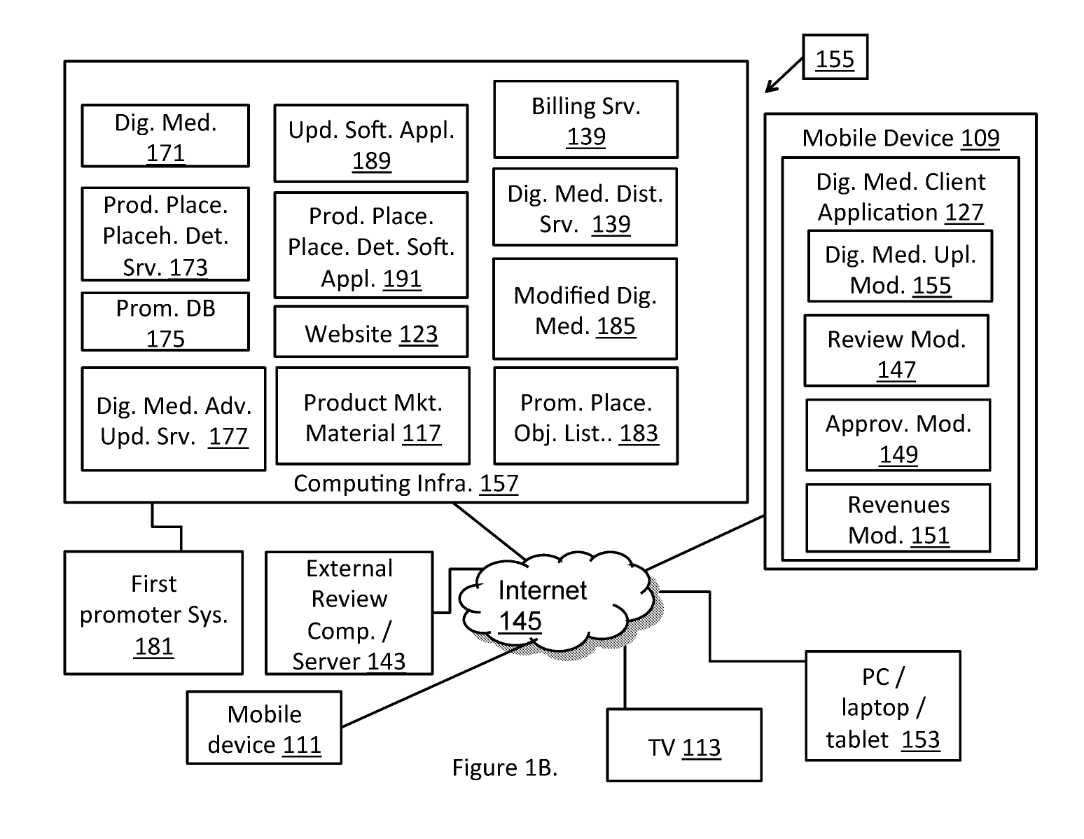

FIG. 1A is a perspective block diagram of a network 105 comprising a computing infrastructure 107 for processing digital media such as movies comprising a product placement capture service (sometimes referred to as the placeholder identification manager 115) that determines placeholder objects, and a automatic replacement manager 131 that selectively replaces some of those placeholder objects identified, wherein the replacements made are driven by product placement needs of product manufacturers and product promoters. The computing infrastructure 107 comprises memory 163, at least one storage 165 configured to store a plurality of processing instructions, and at least one processor 161 in communication with the at least one storage. The at least one processor 161 of the computing infrastructure 107 are configured to execute instructions to identify placeholder objects and their corresponding locations in a movie/digital media, and to determine, selectively, appropriate replacements for the placeholder objects among a plurality of product placement material (uploaded by product manufacturers, for example).

The infrastructure 107 for processing digital media comprises a digital media upload service 129 that provides a first digital media 135 received from a remote source, such as a PC/laptop/tablet 153 or a server, and a product placement capture service 115 that provides a first product placement interface data, the first product placement interface data including at least one product placement item 117. It also comprises a first product finder service 103, that processes the first digital media 135 to find a plurality of distinguishable objects and stores them as placeholder objects 121, along with their frequency of occurrence and corresponding locations in the first digital media 135.

The infrastructure 107 also comprises a first product replacement service 131 that processes the first digital media 135 to replace at least one of the placeholder objects 121 with at least one of the at least one product placement item 117, to create a modified first digital media that is distributed as necessary by a digital media distributed service 119.

In one configuration of the infrastructure 107, the first digital media 135 is a movie. In a related configuration, the first digital media 135 is a video clip created by a user for sharing. In yet another related configuration, the first digital media 135 is an audio clip or song created by a user for sharing/distribution.

a digital media distribution service that distributes the modified first digital media to a plurality of client devices. Other type of digital media, such as animations, 3D images, maps are also contemplated.

A used products list 125 for the digital media 135 that is also provided in the first digital media data, that a digital media upload service 129 stores for subsequent processing makes it easy to search for those items in the movie and determine placeholders. For example, the first product finder service 103 employs the used products list 125 in determining the plurality of distinguishable objects and their corresponding locations in the first digital media 135.

In one configuration, the product placement capture service 115 scales the at least one of the at least one product placement item 117 as necessary before using them to replace corresponding ones of the at least one of the placeholder objects.

In one configuration, a billing service 139 charges a billing amount to an account associated with an organization managing the at least one product placement item for services rendered, wherein a portion of a billing amount is paid to a second account associated with a second organization as payment for placement of the least one product placement item in the digital media. For example, the billing service 139 charges a billing amount to an account of a product promoter or a marketing firm associated with the products that are placed into the movie, while at least a portion of the billing amount is paid to a second account associated with a movie producer or a movie making company.

The computing infrastructure 107 replaces at least one of the extracted placeholder objects with at least one of the appropriate replacements using the corresponding locations and outputs a modified digital media. For example, one of the extracted placeholder objects in a movie is a bottle of red wine, and the replacement for that provided by a winemaker in Napa is a Robert Mondavi Cabernat Sauvignon bottle, which the computing infrastructure 107 uses to swap the placeholder object (bottle of red wine) out. Based on configuration or user preference, such swapping can be at a first place of occurrence of the placeholder object in question, at a first few places (such as the first 5 places/locations in the movie where it is encountered), throughout the movie, or in specific scenes in the movie.

The computing infrastructure 107 also distributes the modified digital media created by selective replacements of one or more placeholder objects encountered in the movie created. Such replacements are post-production of a movie, and before its release in one embodiment, during movie production in another embodiment, after individual scenes are completed but the movie is only partially completed, and after release of the movie in another related embodiment. In a related embodiment, the computing infrastructure 107 is employed in post-production activities in movie production, along with, or as part of, a clearance confirmation activity/process.

In one embodiment, the computing infrastructure 107 supports the activities of a clearance coordinator for a movie, who is responsible to ensure all rights and clearances are obtained for the movie being produced. It helps track licenses and approvals obtained for the placeholder objects or for a subset thereof. It supports activities related to securing licenses or rights for the use of copyrighted material. It facilitates managing a list of copyright holders, generating clearance requests and other correspondence to the copyright holders, and receiving and storing of appropriate license agreements.

Based on configuration, the computing infrastructure 107 is used by a user to optionally conduct clearance activities associated with placeholder objects determined to be present—such determination being conducted automatically by the computing infrastructure 107 or manually by the user with its help. The clearance activities supported/tracked include:
Locating the appropriate contact/owner for obtaining the permission (such as a legal firm or trademark owner) as necessary, for the placeholder objects 121;
For each placeholder object 121 considered as important/essential, communicating directly with the company/brand owner and selling the production;
Collecting and providing script pages, show synopsis and intended use to any manufacturer or product promoter/company; and
Manage and track follow-up calls and correspondence with all parties for confirmation.

In one configuration, there are three basic types of product placements supported by the infrastructure 107: visual, spoken and usage. A visual product placement occurs when a product, service, or logo can simply be observed. The infrastructure 107 conducts swapping out products from a movie, such as by replacing one image with another provided by a manufacturer or promoter. A spoken product placement occurs when an actor or off-screen voice mentions a product, service, or corporation. Replacing audio clips with another that promotes a different product or service is supported by the infrastructure 107. In one related configuration, replacement of voice clips (segments of audio from a movie, for example) occurs without voice-overs by the corresponding actors. For example, an audio synthesizer mimics an actor's voice inputs and creates a replacement audio clip, to be used for product placements, wherein the replacement audio clip synthesized is based on voice characteristics and speech patterns of the actor, which is determines by an analysis of the audio channels for the movie/digital media. A product placement usage occurs when an actor or actress actually handles or interacts with a product, service, or corporation. A placement that involves usage often includes both a visual and spoken element as well. User-specified product placement information, provided by the user to facilitate placeholder object detection and tracking, is collated and managed. This is enhanced by automated or guided detection of additional placeholder objects.

In embodiment, the infrastructure 107 also supports clearance activities for movies. It should be important to note that placeholder objects for which a manufacturer or license holder does not provide clearance is replaced by using the product replacement services provided by the present invention.

In one configuration, the infrastructure 107 also supports remote product replacement by a remote user using a product selection & replacement computer 141 that helps the user connect to the computing infrastructure 107, browse through placeholder objects 121, select product placement items 117 for replacement, and then save the modified movie version thus created for subsequent processing and/or merging with other versions of the modified movie, as necessary, that are created by other promoters of products, etc. The product selection & replacement computer 141 also enables a user to receive clearances for products placed, upload clearances to the computing infrastructure 107, and manage the clearances received.

The computing infrastructure 107 facilitates clearance activities for digital media/movies. It should be important to note that placeholder objects for which a manufacturer or license holder does not provide clearance are replaced by using the product replacement services (such as those provided by the product replacement service 131) provided by the present invention.

Based on user activation and configuration, the computing infrastructure 107 is enables manual specification of product replacements. For example, at specific locations in the movie that is flagged, a user swaps out or replaces the placeholder objects (one or more) with replacements selected from a collection of product placement objects available. Product marketing material uploaded by manufacturers and promoters are received by appropriate interfaces. Such product marketing material (also referred to as the one of the plurality of product placement material) are stored in a database or in storage 165, and used as necessary to replace placeholder objects that are manually or automatically identified in the movie.

Another exemplary method of conducting product placements on digital media, such as movies and video clips, for example during post-production activities for the digital media, comprises tasks performed by a computing device comprising a processor, memory and storage. The exemplary method conducted by the computing infrastructure 107/device comprises identifying placeholder objects 121 and their corresponding locations in a digital media 135 and storing such information, such as in a database, and then determining selectively appropriate replacements for the placeholder objects among a plurality of product placement material 117 (with user participation or in an automated mode), before finally replacing at least one of the extracted placeholder objects with at least one of the appropriate replacements using the corresponding locations and outputting a modified digital media.

The exemplary method of conducting product placements also includes distributing the modified digital media on demand and broadcasting the modified digital media based on a schedule. The digital media is a movie in some configurations and the modified digital media is a movie comprising at least one of the plurality of product placement material 117. Identifying placeholder objects, in some configurations involve determining scenes in the digital media and then processing each scene to extract a catalog of placeholder objects with corresponding locations of those placeholder objects in that scene.

In some configurations, replacing at least one of the extracted placeholder objects 121 comprises comparing, for each scene, the catalog of placeholder objects from 121 with the plurality of product placement material 117 or a subset thereof, to identify the at least one of the appropriate replacements, and then swapping, in each scene, the at least one of the extracted placeholder objects in that scene with corresponding ones of the at least one of the appropriate replacements for that scene identified by the comparing.

In one configuration, comparing placeholder objects 121 to product placement material 117 is conducted manually by a user in some configurations, as are the swapping operations that replace the placeholder objects with relevant/useful ones from the product placement material—these manual operations are conducted by a user employing the computing device, wherein the computing device provides display screens to display individual frames of digital media (and other details of the digital media at various granularity, frame rate, colors, background manipulation, etc.) and also solicits user input. The computing infrastructure 107 guides a user, via user input screens, user prompts, user instruction sidebars, etc. to select the at least one of the appropriate replacements; and swap, in each scene, the at least one of the extracted placeholder objects with corresponding ones of the at least one of the appropriate replacements for that scene.

In some configurations, the digital media is a video clip and the modified digital media is a video clip comprising at least one of the plurality of product placement material. In some other configurations, the digital media is an audio clip and the modified digital media is an audio clip comprising at least one of the plurality of audio product placement material.

In one embodiment, the computing infrastructure 107 of this disclosure relates to a cloud computing system that comprises a plurality of computing nodes and a virtualization layer configured to create a virtual computing environment on each of the plurality of computing nodes. The infrastructure configures to receive an authorization to service a product placement plan, the product placement plan being from a user and including at least one instance to replace placeholder products identified within a specific movie with products promoted by product manufacturers. In response to the authorization for product placements, the computing infrastructure 107 is used to identify at least one placeholder object that as a target for replacement. In addition, the infrastructure includes the ability to search the plurality of computing nodes based on at least one end user product placement needs and identify at least one computing node having one or more computing resources that can meet those needs. The computing infrastructure 107 launches the auto replacement manager 131 with the proper configuration to effect desired product replacements, employing the assigned/identified at least one computing node. Note that based on configuration, the manual replacement manager 133 is launched to enable manual specification of product replacements, at specific locations in the movie flagged by the placeholder identification manager 115, which can be verified by a user using the placeholder browser manager 135, thereby making it possible to manually replace specific instances of the placeholder objects, as selected by the user, employing specific ones of the product marketing materials or subsets thereof provided by the product manufacturers.

In one configuration, employing scene change detection and image processing, the first product finder service 103 facilitates placeholder object detection by processing the first digital media 135 to find a plurality of distinguishable objects and stores them as placeholder objects 121. In a related configuration, scene change detection is the process of identifying points in a temporal sequence of images at which ensuing images are no longer related in content to the preceding images. Image sequences in the form of digital video data, occupies an important and share of the video processing and object detection in this invention. The process of detecting scene transitions is useful, including but not limited to rapidly identifying new scenes in composite video sequences (for instance in the editing of video clip or movie footage), capturing frames at the beginnings of new video scenes for indexing or cataloging purposes and placeholder object detection purposes, etc.

In one embodiment, the process of scene change detection is employed in a post processing step for a digital content such as a video clip or a movie. A list of scenes detected is collected. Then, for each scene detected, further image processing is conducted to determine objects in those scenes. Such object detection conducted by the product finder service 103 (or in general by an object finder unit) is guided by a list of known objects provided in one configuration (which is provided by the movie maker, for example, using the product placeholder capture service 115), and without any such list in another embodiment (where a default list of anticipated objects to be located is selectively employed). The locations of those objects detected in each of the scenes are marked and noted down for potential replacement by images of other similar objects subsequently, during a content update phase by the product replacement service 131 and associated applications, prior to dissemination, or as a per user custom content delivery activity during a streaming download of content or during a live delivery of the content to multiple users.

Specifically, in one embodiment, a scene detection unit (also called the scene detection manager 167) distinguishes scene changes from internal motion, intensity shifts, color changes, and occlusions in the movie or digital media, and it does so efficiently enough to be applied advantageously to the problem of video compression, and product replacement.

In one related specific embodiment, two or more consecutive images from a sequence are introduced to a segmenter of a scene detection manager 167 of the product finder service 103 as digital frames. The segmenter independently divides each of these frames into pixel regions or segments according to some common characteristic so that every pixel belongs to exactly one segment. A segment analysis unit then performs some statistical analysis on the segment data for each of the frames and generates composite statistics for each frame. A frame comparison unit then examines these composite statistics to determine whether these frames belong to a consistent scene of images. If the composite statistics for these frames differ sufficiently, the comparison unit declares the latter frame in the sequence to belong to a new scene. This information may then be transmitted back to the product finder service 103 for the purpose of marking the scene change or for any other purpose.

In a related embodiment, the scene detection manager 167 for detecting scene changes in the product finder service 103 (or in a related application) in a sequence of video frame (of a movie or digital media) comprises a segmenter for dividing the video frames into non-overlapping segments of varying shapes which a segmentation analysis unit then analyses to gather statistical information about the segments in the video frames. The Segmentation analysis unit accepts as its input segment lists and outputs compiled segment statistics for each image frame. Then a frame comparison unit compares the statistical information for temporally consecutive video frames using a statistical measurement and identifies frames at which an abrupt change in the statistical measurement is indicative of a scene change. A list of scene changes and a list of scenes is created, which is optionally reviewed manually or computationally to verify that the scenes changes are accurately identified so to update the list of scenes.

In one configuration, the statistical information about the segments in a frame comprises a histogram in some configurations, wherein the histogram records a number of segments in each of a plurality of pixel size ranges. For example, a histogram would record the number of segments in each of several size ranges, where the size range bins for example may be 1-200 pixels, 201-300 pixels, 301-400 pixels, etc. It is important to note that the division of pixel size or other segment attributes into ranges for the purpose of storage/binning may vary. Alternatively, the histogram records a number of segments in each of a plurality of color ranges.

In one configuration, the scene change information/list is then used, by the scene detection manager 167, for analyzing each scene for the occurrence of recognizable objects that can be subsequently replaced by other equivalent objects/images, if necessary. A scene specific catalog of objects for each scene is maintained and subsequently used for object replacements within the individual scenes or across the whole video clip/movie, as necessary. Thus, determining sections of a video clip or a movie (first digital media 135) where the specific objects occur, or locations in individual frames where those objects are automatically detected or confirmed to occur, is useful. The occurrence and location of specific objects (a list of objects to look for is provided in some configurations) within a frame is noted down in a per scene list of object locations, or in a per frame list of objects and their corresponding locations.

Manual scene detection is also facilitated by the scene detection manager 167 is one embodiment. It enables a user to manually review the first digital media, to pause, to mark a frame as the beginning of a scene, or to indicate to a viewer that a new scene has been detected, etc.

In one embodiment, the scene detection manager 167 also employs an object finder unit that recognizes an object in an image in a frame by providing, multiple stages of image scaling of segments of a frame in a movie and comparison to reference objects. At a first scaling stage of a scaling region of the image, and at subsequent scaling stages of the scaling region of the image, the image is subdivided into at least one image segment and subsequently deciding for the at least one image segment on the first scaling stage of the scaling region as to whether the at least one image segment is considered on the at least one further scaling stage of the scaling region. This multi stage image decomposition and scaling and comparing to a reference object (reference image) is terminated when a reasonable match is detected by some levels of staging.

In another embodiment, the object finder unit of the product finder service 103 recognizes an object in a source image extracted from a frame (could be an image created from the entire frame, for example). The source image is one in which the object is intended to be recognized, and it is subdivided into image segments, and the image segments are investigated for different scaling stages of the image. Here, the term scaling relates to the change in size of a digital image in the case of which a new image with a higher or lower number of pixels is generated. It is advantageous here when the image segments are initially investigated only for one scaling stage and, in so doing, it is estimated whether an object to be recognized will be included for further scaling stages in the image segment. It is expedient to start the scaling at a lower scaling stage, the further scaling stages lying thereabove, that is to say ever larger image segments are analyzed, starting with a smaller one initially. In this way, there is no longer any need to investigate for further scaling stages those image segments for which an object to be recognized will not be present in any case. This saves computing time and therefore accelerates object recognition.

In one embodiment, detecting a given object by the product finder service 103 in a frames or a set of frames requires, for example, comparing the given object (actually a target image representing the given object) to different sections of the frame or a set of frames, and computing a likelihood of a match. The task of an object finder unit in the product finder service 103 (also sometimes called an object detector) is to find/locate objects in different sizes and positions in the image using the target image. For this purpose, it is routine to use classifiers which receive as input a vector comprising calculated features of an current image segment comprising the specified object. The output is a binary decision as to whether the considered image segment includes the specified object. In order to find specified objects at all positions in the source image, each image segment from the source image is selectively scaled to different levels and compared to the target image that is pushed over the scaled image segment, and the object detector is applied at each site. In order, in addition, to find objects of different sizes, the object detector is applied to scaled versions of the target image. The product of the number of scaling and the positions in the image yields the number of required classification runs, and influences the run time and the accuracy of the object detection.

In one embodiment, a particular example of a method for detecting an object by the product finder service 103 inside a video scene, starts with creating a source image from each frame, or from a set of frames, and then attempting to detect the specified object (using its target image) within individual segments of that source image. If an object is not specified, or a list of anticipated objects is not provided, then a default list of anticipated objects and corresponding target images is used, and the occurrence of each object within that anticipated list is determined.

In one embodiment, the object finder unit of the product finder service 103 in one configuration takes as input an image with an unknown object (shape) identified within the frame of a video clip or movie and compares it to a model image specified for the object to be located. It solves the correspondence problem between the model image and the unknown object in the frame, using the correspondences to estimate and perform an aligning transformation and computing a similarity based on both the aligning transform and the residual difference after applying the aligning transformation. This method/computation is used for object recognition by using stored exemplars as models for different objects to be located from various categories, possibly with multiple exemplars for different aspects of an object to be located.

The object finder unit of the product finder service 103 in one configuration employs a component division unit that divides an input object image in a frame (from a video, for example) into a plurality of sub component images. An object descriptor generating unit generates object descriptors using a transform matrix corresponding to the respective object component images, the object descriptors being characteristic vectors. The transform matrix transforms the object image such that dispersion in the object image vectors having the same identification decreases, while dispersion in the object image vectors having different identification increases. A registered object descriptor database (DB) stores registered object descriptors for the products registered as reference objects, such as those provided by a movie maker as anticipated objects. An authentication unit authenticates the input object image from a frame by comparing object descriptors for the input object image (provided to detect one or more anticipated objects) with descriptors from the object descriptor generating unit with the registered product placement material descriptors (used as a reference). It provides predetermined weights corresponding to each object component to the comparison results of each object component. In a related configuration, a transform matrix generator generates a linear transform matrix for each object component image where the linear transform matrix maximizes a ratio of dispersion in object images having different identification to dispersion in objects images having the same identification.

In a related embodiment, according to the present invention, the object image is divided into object component images (e.g., top side images, bottom side images, side images, and front-side images), object recognition of reference objects, such as objects anticipated to be present in the movie/frame, is performed on the object component images, not on the entire object image, and changes in the object image due to changes in positioning are compensated for by only adjusting translational offsets, not complex matching or warping.

FIG. 1B is a perspective diagram of an exemplary infrastructure 157 for enhancing movies, the infrastructure 157 comprising a digital media 171 and a product placement placeholder determination service 173 that provides a first interface data received via a promotion capture interface of a first promoter system 181, to a first product placement placeholder determination software application 191. The first interface data includes a first promotion data using which the product placement placeholder determination software application 191 processes the digital media 171 to produce a first promoter placeholder objects listing 183 that it makes available via a product placement management interface for management from the first promoter system 181. The infrastructure 157 also comprises a promotion database and a website 123 that exposes various services and interfaces for remote access.

The product placement placeholder determination service 173 stores a first promotion data and the first promoter placeholder objects listing, as necessary, in the promotion database 175 or in some form of storage system available. The first promotion data comprises a first product marketing items list, a first configuration, and a first identifier code, in one configuration.

The infrastructure 157 also comprises a digital media advertisement update service 177 that provides an update interface to an update software application 189 that navigates through each occurrence in the digital media 171 of the individual items of the first promoter placeholder objects listing, enabling selective replacements of the individual items of the first promoter placeholder objects listing with corresponding ones from the first product marketing items list 117, the update software application 189 creating a modified digital media 185 after replacements. The digital media advertisement update service 177 enables review and approval of the modified digital media 185 using a second software application. For example, the second software application is a review & approval application capable of frame by frame review of replaced placeholder objects (with product placements) and a navigation view where the user navigates from a first known placeholder object to the last known placeholder objects with next and previous navigation possible on subsequent placeholder object locations between the first and the last one.

In one configuration, the infrastructure 157 for enhancing movies further comprises a billing service 139 that provides access to a billing software application that processes the modified digital media 185 to determine a billing amount that the billing software application communicates to the first promoter system 181. For example, billing occurs based on several parameters including the number of scenes where a type of placeholder object is replaced by one of the product marketing material instance provided by a product promoter. Billing also occurs based on number of different type of products be “placed” by the promoter, such as wine bottles and cheese packets, etc.

In one configuration, the infrastructure 157 further comprises a digital media distributing service 139 that provides a digital media distributing interface to a plurality of remote client devices 153, 113, 111 through which the infrastructure 157 distributes the modified digital media 185 after its approval.

In one configuration, the digital media distributing service 139 provides a digital media distributing interface to an external media server 143 through which the external media server 143 retrieves the modified digital media 185 for eventual distribution to a plurality of client devices.

In one configuration, infrastructure 157 further comprises the product placement placeholder determination service 173 providing a second interface data received via the promotion capture interface of a second promoter system (similar to the first promoter system 181), to a second product placement placeholder determination software application, the second interface data including second promotion data using which the second product placement placeholder determination software application processes the digital media to produce a second promoter placeholder objects listing that it makes available via the product placement management interface for management from the second promoter system (similar to 181). In this configuration, multiple promoter systems, associated with different product promoters for example, allow access to the processing of the same digital media 171 hosted by the infrastructure 157, and each promoter systems 181 allows an authorized user to determine their own set of placeholder objects from the digital media 171, wherein each promoter can also bid for product placements in specific scenes of the movie, and also bid for product placements for beginning of the movie, end of the movie, product placements in “dramatic events” in the movie, etc.

The digital media advertisement update service 177 provides the update interface to the update software application 189 that navigates through each occurrence in the digital media of the individual items of a second promoter placeholder objects listing 183, enabling selective replacements of the individual items of the second promoter placeholder objects listing 183 with corresponding ones from a second product marketing items list 117, the update software application 189 creating a second modified digital media 185 after replacements.

In one configuration, a distribution ready software application merges the modified digital media form the first promoter, and the second modified digital media from the second promoter, to create a final modified digital media that is ready for distribution and sharing via the digital media distribution service 139, or from an external server which obtains the final modified digital media for eventual distribution over Internet, etc.

A mobile device 109 is also used, in one configuration, to manage placeholder object replacement using a digital media client application 127, which comprises a digital media upload module 155 to upload user created digital media such as a video clip. The user is able to review a modified digital media created by the infrastructure 157 using a review module 147, and approve the inclusion of product placement for the automatically identified placeholder objects (without user involvement in identification) using an approval module 149. Any revenues generated from the replacement of placeholder objects with actual product placements are reviewed using the revenues module 151.

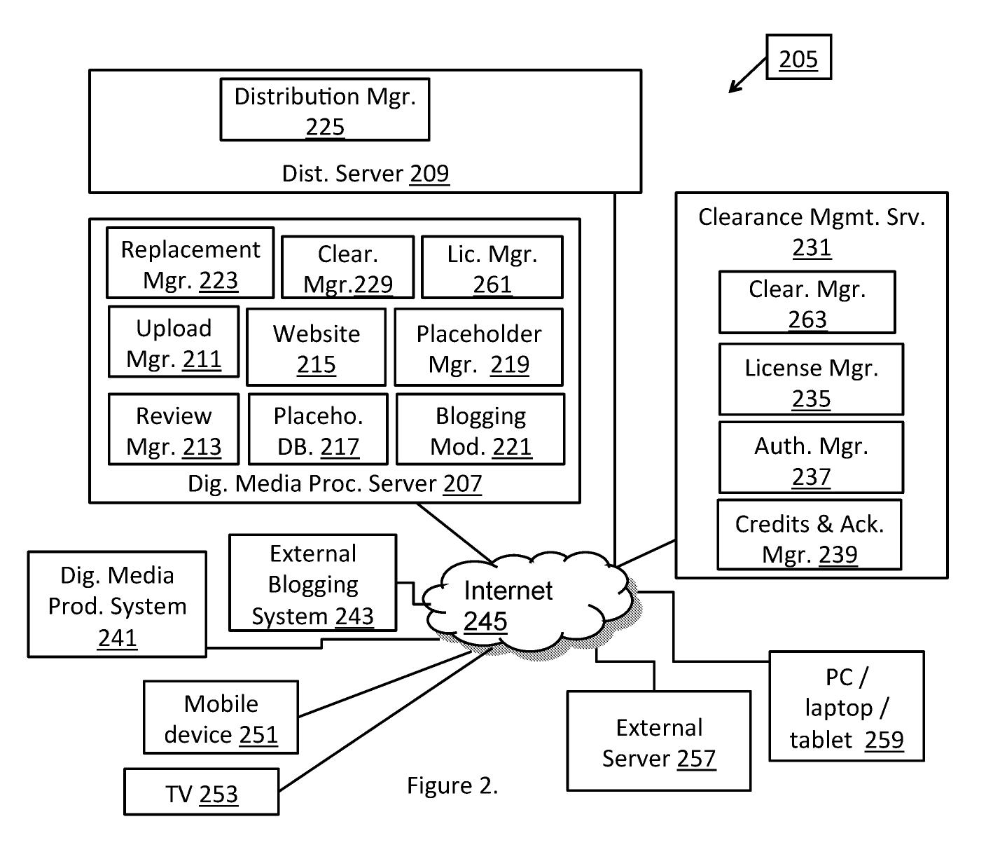

FIG. 2 is a perspective block diagram of a infrastructure 205 for product placements in movies and other forms of digital media, wherein a digital media processing server 207 receives and processes a digital media provided by a digital media production system 241 and conducts post-production product placement activities as well as clearance management activities. The digital media processing server 207 is configured to process a digital media uploaded using the upload manager 211, determine placeholder objects if any and store them in a placeholder database 217, and facilitate product placement activities employing a replacement manager 223 as well as conduct clearance management activities employing a clearance manager 229.

The clearance manager 229 analyzes placeholder objects to facilitate marking those placeholder objects (in the various scenes of the movie, for example) that need clearances (from artists, painters, organizations, etc.). For example, the timing or duration of the song and the visuals accompanying the song are stored and tracked by the clearance manager 229, as well as the timing or duration of the display of a logo and the visuals accompanying the logo are stored and tracked. It then tracks obtaining clearances, and also manages collecting, updating and publishing clearances. In addition, for each placeholder object that is replaced with a product placement material (obtained legally from a promoter of products), the usage of the marketing material provided by the promoter and the license for using that marketing material is tracked by the clearance manager 229. If a promoter fails to provide a clearance for the use of a marketing material for replacement, then the clearance manager 229 marks those associated placeholder objects for additional replacement with a new product placement to be conducted by the replacement manager 223, or marks it for reversal of the replacement at those locations back to the original content prior to the first replacement. Similarly, an external clearance manager server 231 is authorized to access placeholder objects and the modified digital media to determine the need for clearances in the various scenes and in the various objects determined to be in those scenes. A license manager 261 that works with the clearance manager stores all licenses and clearances obtained for various placeholder object replacements conducted. The clearance manager 229, in one configuration, provides screens (through the website 215 for example, or via other interfaces) for browsing through placeholder objects that are stored in the placeholder database 217. Such browsing is also conducted, based on user preference, by scenes, or from a first placeholder object to the next until the end (and back in reverse order too, etc.). The clearance manager 229 helps a user determine all the various replacements planned, all the placeholder objects marked for replacements, and it communicates and tracks clearance needs for those replacements by product placement materials, etc.

The clearance management server 231 also employs a credits & acknowledgement manager 239 to collate various credits for various products and artistic material used in the modified digital media. It publishes a credits and acknowledgement report in several formats that can be printed or even incorporated into the modified movie before distribution by a distribution server 209.

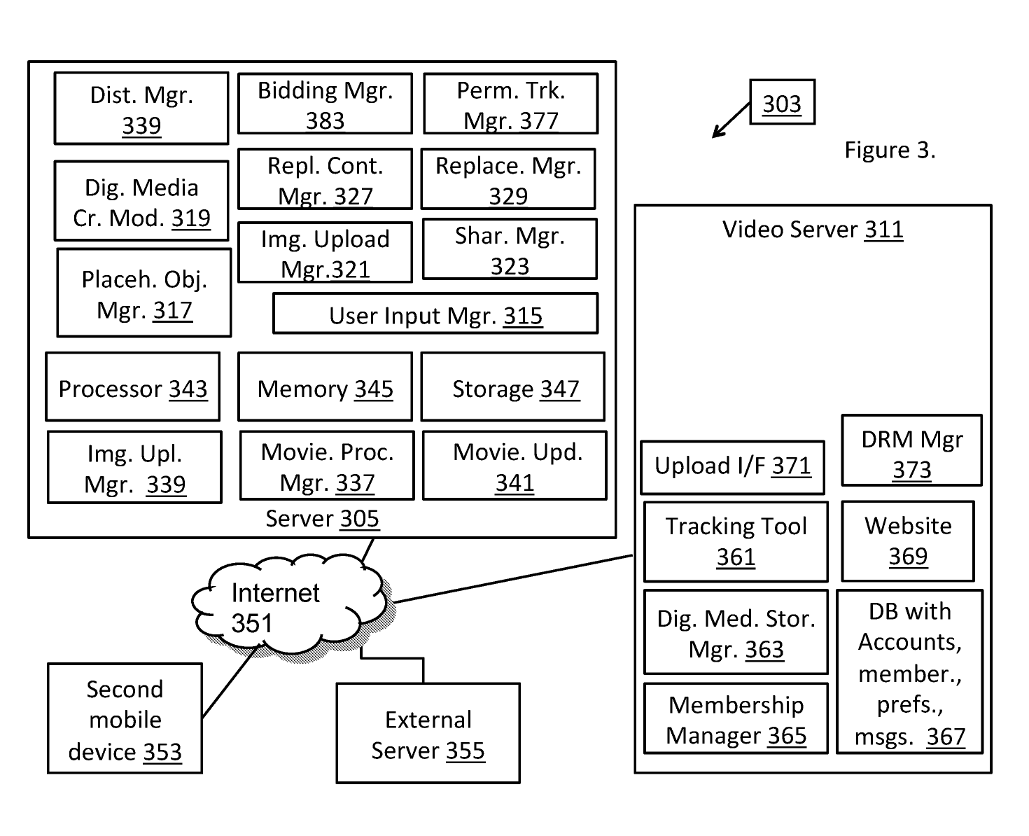

FIG. 3 is a perspective block diagram of a infrastructure 303 for product placements in movies and other forms of digital media, wherein a server 305 processes the digital media, facilitates product placements, and distributes a modified digital media with product placements included in them. The server 305 for processing movies comprises a storage 347, a memory 345 and a processor 343 in addition to communication circuitry and digital processing means. The server 305 also comprises an image upload manager 321 that receives and stores a plurality of images to be used as product placement and a movie processing manager 337 that receives and stores a movie and other forms of digital media. The movie processing manager searches for the occurrence of placeholder objects in the movie and assembles a placeholder objects list and corresponding locations in the movie where they are determined to occur. A movie updater 341 replaces specific occurrences of placeholder objects in the movie with corresponding ones of plurality of images, and creates a modified movie that a distributing manager 339 distributes to video servers 311 and to end user devices such as a second mobile device 353.

The distributing manager 339 communicates the modified movie to a video server infrastructure 311 for subsequent distribution and tracking of usage, wherein the video server reports details of usage that selectively are employed for billing purposes, such as when billing is based on audience size, regions of distribution, etc.

In one configuration of the server 305, the placeholder objects are provided by a user, using the placeholder object manager 317, and user provided placeholder objects are enhanced by addition of other server identified placeholder objects.

The server 305 is configured in one embodiment to receive and process a movie using a user specific placeholder objects provided by a user, that is added to the placeholder objects list managed by the placeholder object manager 317, to create an updated placeholder objects list, wherein the movie updater 341 replaces specific occurrences, in the movie, of placeholder objects from the updated placeholder objects list, with corresponding ones of plurality of images, and creates a modified movie. For example, a promoter of products provides the plurality of images to be used in replacement of placeholder objects provided by the user/maker of the digital media. Additional placeholder objects are identified by the server 305, that are included in the updated placeholder objects list. The updated placeholder objects list is then used for manual replacement using a replacement manager 329. Similarly, based on configuration, the updated placeholder objects list is then used for automated replacement using the replacement manager 329.

The server 305 also facilitates creation of digital media using a digital media creation module 319, which is then processed for product placements. In addition, a user can add product placement content (such as images, songs, 3D maps, etc.) using the image upload manager 321 and manage them subsequently using a replacement content manager 327.

The server 305, in one configuration further comprises a placeholder objects manager 317 that provides access to the placeholder objects list from a plurality of client devices communicatively coupled to the server. Users can then review these placeholder object, and plan on replacing them with product placements using other images and marketing material. The placeholder objects manager 317 facilitates browsing of the placeholder objects list and selection of items from the placeholder objects list, by a product promoter (using the external server 355 for example), as targets for replacement. The movie updater 341 replaces specific occurrences of the placeholder objects in the digital media/movie that are specified as targets for replacement, with corresponding ones of plurality of images, and creates the modified movie, which upon an approval process, is distributed/shared.

In one configuration, the image upload manager 321 receives and stores a plurality of images to be used as product placement, from each of a plurality of users, and aggregates them in an aggregated plurality of images. The movie processing manager 337 searches, for each of the plurality of users, for the occurrence of placeholder objects in the movie and assembles a placeholder objects list, for each of the plurality of users, and corresponding locations in the movie where they are determined to occur. The placeholder objects manager 317 creates an aggregated placeholder objects list from the placeholder objects list created for each of the plurality of users. The movie updater 341 replaces any of the specific occurrences of the placeholder objects from the aggregated placeholder objects list in the movie, employing corresponding ones of the aggregated plurality of images, in creating the modified movie.

In one configuration of the server 305 for processing movies, the movie updater 341 provides screens for manual replacement of any of the specific occurrences of the placeholder objects in the movie by an authorized user, employing corresponding ones of plurality of images, in creating the modified movie. In another related configuration, the movie processing manager 337 provides screens for manual searches of the movie by a plurality of users for the determination of placeholder objects in the movie, and assembles the placeholder objects list and corresponding locations based on the manual searches.

In another configuration, each of the plurality of users (promoters for example) provide a user specific list of anticipated objects to be used in the movie, and the movie processing manager provides screens for manual searches of the movie by these plurality of users, wherein the occurrences of the anticipated objects are confirmed, and their locations marked, for further processing leading to product placement activities. A user input manager 315 provides screens for user interactions, such as for browsing through the placeholder objects, reviewing the modified movie, checking clearances obtained for products placed/replacements made, etc. The user input manager 315 also enables creating and reviewing a report identifying all clearance issues, music, products and brands used for product placements, and permission requirements that are being tracked by a permission tracking manager 377.

Video server 311 is responsible for distributing the modified digital media that it receives from the server 305, which it stores in a storage or a database that is managed by a digital media storage manager 363. Modified digital media are uploaded by the server 305 to the video server 311 employing an upload interface 371. Video server 311 provides DRM based security and access control facilities employing a DRM manager 373. It tracks, using a tracking tool 361, the usage of the modified digital media, the frequency of usage by members and non-members, the interest level shown by users in specific product placements, the user-interactions via the product placements in the movie in configurations where such interactions are possible, etc. It communicates the tracking information collected to the server 305 for analyses. A website 369 provides search and retrieve support for digital media available for download, streaming or viewing. A membership manager 365 provides support for membership management—adding, deleting members and managing lifecycle of subscriptions. A database with user accounts, membership histories, user preferences and user messages 367 provides storage and management of various kinds of user-related, data related information, media related and operations related information.

The server 305, employing a bidding manager 383, also facilitates bidding for product placements in specific scenes by one or more promoters, and bidding for product placements by various promoters in specific dramatic moments in the movie/digital media. For example, two different marketing companies A and B, each promoting a same type of computers, but for different manufacturers, make bids using the bidding manager 383 for product placements in a third scene of the movie by identifying a placeholder object 55 in the third scene, in which they prefer to have their products placed—by replacing the placeholder object 55 for a certain duration in the scene. The bidding manager, for example, receives bids for each scene, and for each placeholder object in the scenes. It then announces bid winners after a deadline date, or after a triggered end of bid event. It publishes winners of bids, and enables product replacements to occur to those associated placeholder objects by triggering the replacement manager 329 to act upon the results of the bidding process.

Thus, the present invention covers another interesting scenario too—each product promoter, using the server 305/infrastructure 107, can now process the same movie (post-production, for example, or as part of clearance activities, for example) independently for determining what placeholder objects want to replace with their products that they plan to promote, or which scenes they want to replace placeholder objects in, and then make a bid for being allowed to achieve their product placement goals. Thus, several bids by various product promoters is received, and evaluated, and several bids are selectively awarded. For example, one product promoter/manufacturer promotes his products in the first 3 scenes of a movie uploaded, while another product promoter/manufacturer promotes her products in the last 3 scenes of the same movie uploaded.

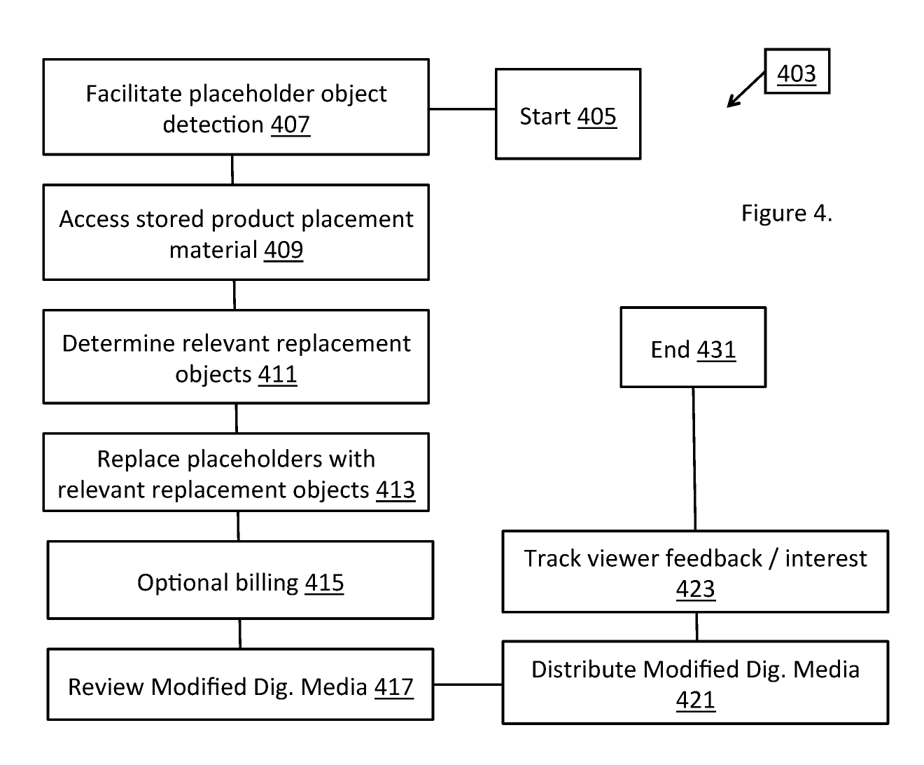

FIG. 4 is a flowchart of an exemplary operation of the infrastructure 107 of FIG. 1 as it 1 as it facilitates automated product placements activities in digital media uploaded. At a start block the infrastructure 107 product placement capture service 115 provides a first product placement interface data, the first product placement interface data including at least one product placement item 117. Then at a next block 407 first product finder service 103 facilitates placeholder object detection by processing the first digital media 135 to find a plurality of distinguishable objects and stores them as placeholder objects 121, along with their frequency of occurrence and corresponding locations in the first digital media 135.

At a next block 409, the infrastructure 107 access stored product placement material. These, for example, are provided by one or more product promoters. These, for example, are also logos, product images, short video clips, 3D images, maps, etc. that are to be used in replacement of placeholder objects.

At a next block 411, the infrastructure 107 in an automatic mode determines relevant replacement objects, based on placeholder objects detected and an available default set of detectable objects or based on a user-specified set of known objects (objects that are anticipated to occur in the digital media). The determination of relevant replacement objects, in one configuration, involves comparing items from an available list of placement material to individual items of a placeholder list, in order to find a reasonably close match, so as to mark those items from the list of placement material as replacements at the corresponding locations in the target placeholder objects.

At a next block 413, the replacements occur, when the product replacement service 131 replaces placeholder objects marked for replacements with relevant replacement items from the available list of placement material. At the end of replacements, the modified digital media is created and stored. Then at a next block 415, optional billing occurs. This, for example, involves identifying owners/promoters of the various replacement items used from available list of placement material, and sending them a computed invoice comprising a computed billing amount. The computed billing amount, for example, is based on the number of replacement items used from that promoter/product manufacturer, the duration of display of those items, the scenes in which they appear, the dramatic value of the scene in the overall scheme of the movie, etc.

Then, at a next block 417, the infrastructure 107 enables review of the modified movie/modified digital media. The user/reviewer also gets a chance to approve its distribution. At a next block 421, the infrastructure 107 distributes the modified digital media. At a next block 423, the infrastructure 107 tracks viewer feedback for the modified digital media, viewer feedback for the product placements, interest shown by viewers in individual items of the various products placed etc. The operation terminates at the end block 431.

In one configuration, at the block 409, the infrastructure 107 in a manual mode facilitates determination by a user of relevant replacement objects.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

The term “computer infrastructure” employed in the present invention includes a set of computers within a distributed network in a data center, a set of on-demand computing power provided in a cloud computing environment, and a geographically distributed network of cloud computing resources that collaborate to provide the services described herein, etc.

The term ‘processor’ used in the present invention includes a series of processors within a computer in the computing infrastructure 107, a distributed on-demand processing power accessed in a cloud computing environment, a set of computers that coordinate their processing power usage in a network, a distributed set of computers across the Internet that provide processing power that can be employed to provide a service, etc.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A infrastructure for processing digital media, the infrastructure comprising:
a digital media upload service that provides a first digital media received from a remote source;
a product placement capture service that provides a first product placement interface data, the first product placement interface data including at least one product placement item;
a first product finder service, that processes the first digital media to find a plurality of distinguishable objects and stores them as placeholder objects, along with their frequency of occurrence and corresponding locations in the first digital media;
a first product replacement service that processes the first digital media to replace at least one of the placeholder objects with at least one of the at least one product placement item, to create a modified first digital media.

2. The infrastructure of claim 1 wherein the first digital media is a movie;

3. The infrastructure of claim 1 further comprising:
a digital media distribution service that distributes the modified first digital media to a plurality of client devices.

4. The infrastructure of claim 1 further comprising:
a used products list for the digital media that is also provided in the first digital media data, that the digital media upload service stores for subsequent processing;
the first product finder service employing the used products list in determining the plurality of distinguishable objects and their corresponding locations in the first digital media.

5. The infrastructure of claim 1 wherein the product placement capture service scales the at least one of the at least one product placement item as necessary before using them to replace corresponding ones of the at least one of the placeholder objects.

6. The infrastructure of claim 1 further comprising:
a billing service that charges a billing amount to an account associated with an organization managing the at least one product placement item for services rendered, wherein a portion of a billing amount is paid to a second account associated with a second organization as payment for placement of the least one product placement item in the digital media.

7. A infrastructure for enhancing movies, the infrastructure comprising:
a digital media;
a product placement placeholder determination service that provides a first interface data received via a promotion capture interface of a first promoter system, to a first product placement placeholder determination software application, the first interface data including first promotion data using which the product placement placeholder determination software application processes the digital media to produce a first promoter placeholder objects listing that it makes available via a product placement management interface for management from the first promoter system;
a promotion database;
the product placement placeholder determination service storing first promotion data and the first promoter placeholder objects listing, the first promotion data having first product marketing items list, a first configuration, and a first identifier code;
a digital media advertisement update service that provides an update interface to an update software application that navigates through each occurrence in the digital media of the individual items of the first promoter placeholder objects listing, enabling selective replacements of the individual items of the first promoter placeholder objects listing with corresponding ones from the first product marketing items list, the update software application creating a modified digital media after replacements; and
the digital media advertisement update service enabling review and approval of the modified digital media using a second software application.

8. The infrastructure for enhancing movies of claim 7 further comprising:
a billing service that provides access to a billing software application that processes the modified digital media to determine a billing amount that the billing software application communicates to the first promoter system.

9. The infrastructure for enhancing movies of claim 7 further comprising:
a digital media distributing service that provides a digital media distributing interface to a plurality of remote client devices through which the infrastructure distributes the modified digital media after its approval.

10. The infrastructure for enhancing movies of claim 7 further comprising:
a digital media distributing service that provides a digital media distributing interface to an external media server through which the external media server retrieves the modified digital media for eventual distribution to a plurality of client devices.

11. The infrastructure for enhancing movies of claim 7 further comprising:
the product placement placeholder determination service providing a second interface data received via the promotion capture interface of a second promoter system, to a second product placement placeholder determination software application, the second interface data including second promotion data using which the second product placement placeholder determination software application processes the digital media to produce a second promoter placeholder objects listing that it makes available via the product placement management interface for management from the second promoter system;
the digital media advertisement update service providing the update interface to the update software application that navigates through each occurrence in the digital media of the individual items of a second promoter placeholder objects listing, enabling selective replacements of the individual items of the second promoter placeholder objects listing with corresponding ones from a second product marketing items list, the update software application creating a second modified digital media after replacements; and
a distribution ready software application merging the modified digital media and the second modified digital media to create a final modified digital media that is ready for distribution and sharing.

12. A server for processing movies, the server comprising a storage, a memory and a processor, the server comprising:
an image upload manager that receives and stores a plurality of images to be used as product placement;
a movie processing manager that receives and stores a movie;
the movie processing manager searches for the occurrence of placeholder objects in the movie and assembles a placeholder objects list and corresponding locations in the movie where they are determined to occur; and
a movie updater replaces specific occurrences of placeholder objects in the movie with corresponding ones of plurality of images, and creates a modified movie.

13. The server for processing movies of claim 12 further comprising:
a distributing manager that communicates the modified movie to a video server infrastructure for subsequent distribution.

14. The server for processing movies of claim 12 wherein the placeholder objects are provided by a user.

15. The server for processing movies of claim 12 wherein a user specific placeholder objects provided by a user is added to the placeholder objects list, to create an updated placeholder objects list, wherein the movie updater replaces specific occurrences, in the movie, of placeholder objects from the updated placeholder objects list, with corresponding ones of plurality of images, and creates a modified movie.

16. The server for processing movies of claim 12 further comprising:
a placeholder objects manager that provides access to the placeholder objects list from a plurality of client devices communicatively coupled to the server;
the placeholder objects manager facilitates browsing of the placeholder objects list and selection of items from the placeholder objects list, by a product promoter, as targets for replacement; and
the movie updater replaces specific occurrences of the placeholder objects in the movie that are specified as targets for replacement, with corresponding ones of plurality of images, and creates the modified movie.

17. The server for processing movies of claim 12 further comprising:
the image upload manager receives and stores a plurality of images to be used as product placement, from each of a plurality of users, and aggregates them in an aggregated plurality of images;
the movie processing manager searches, for each of the plurality of users, for the occurrence of placeholder objects in the movie and assembles a placeholder objects list, for each of the plurality of users, and corresponding locations in the movie where they are determined to occur;
a placeholder objects manager creates an aggregated placeholder objects list from the placeholder objects list created for each of the plurality of users; and
the movie updater replaces any of the specific occurrences of the placeholder objects from the aggregated placeholder objects list in the movie, employing corresponding ones of the aggregated plurality of images, in creating the modified movie.

18. The server for processing movies of claim 12 wherein the movie updater provides screens for manual replacement of any of the specific occurrences of the placeholder objects in the movie by an authorized user, employing corresponding ones of plurality of images, in creating the modified movie.

19. The server for processing movies of claim 12 wherein the movie processing manager provides screens for manual searches of the movie by a plurality of users for the determination of placeholder objects in the movie, and assembles the placeholder objects list and corresponding locations based on the manual searches.

20. The server for processing movies of claim 12 wherein the each of the plurality of users provide a user specific list of anticipated objects to be used in movie processing manager provides screens for manual searches of the movie by a plurality of users.
